(19) United States
(12) Patent Application Publication
(10) Pub. No.: US 2003/0084611 A1
(43) Pub. Date: May 8, 2003

(54) Decorative grower's containers and methods for using same

(76) Inventor: Donald E. Weder, Highland, IL (US)

Correspondence Address: DUNLAP, CODDING & ROGERS P.C., PO BOX 16370, OKLAHOMA CITY, OK, 73114, US

(21) Appl. No.: 10/326,251

(22) Filed: Dec. 18, 2002

Related U.S. Application Data
(63) Continuation of application No. 09/944,771, filed on Aug. 31, 2001.
Application No. 09/944,771 is a continuation of application No. 09/399,858, filed on Sep. 21, 1999, now abandoned.
Application No. 09/944,771 is a continuation of application No. 09/399,860, filed on Sep. 21, 1999, now abandoned.

(51) Int. Cl. A01G 9/02

(52) U.S. Cl. 47/65.7

(57) ABSTRACT

Methods are provided for growing a plant in a grower's container at a grower's location prior to shipment to wholesale or retail distribution points for sale of the plant, the grower's container having an aesthetically pleasing appearance without the use of a decorative cover when a grown plant contained therein is on display at wholesale or retail distribution points.

### CROSS REFERENCE TO RELATED APPLICATIONS

This application is a continuation of U.S. Ser. No. 09/944,771, filed Aug. 31, 2001, now abandoned; which is a continuation of U.S. Ser. No. 09/399,858, filed Sep. 21, 1999, and also a continuation of U.S. Ser. No. 09/399,860, filed Sep. 21, 1999, both abandoned.

### STATEMENT REGARDING FEDERALLY SPONSORED RESEARCH OR DEVELOPMENT

Not applicable.

### BACKGROUND OF THE INVENTION

1. Field of the Invention.

The present invention relates generally to containers in which a plant is grown and methods for using same, and more particularly, but not by way of limitation, to containers used by a grower of a plant having a decorative pattern thereon and methods for using same.

2. Brief Description of the Prior Art.

Various types of containers have been used for many years by growers of botanical items. The containers serve the purpose of growing the botanical items, but upon shipment to retail florists or other distributors, the container is typically covered with a decorative cover or sleeve to hide the unattractive container, or the botanical item is transplanted into a more attractive container.

Although the prior art methods of covering the container in which the botanical item is grown or transplanting the botanical item into a more attractive container have been widely accepted, new and improved methods for growing botanical items in a more attractive container are being sought. These methods would eliminate both time and the expense of the cover or second container. It is to such decorative grower's containers and methods for using same that the present invention is directed.

### SUMMARY

According to the present invention, a decorative container is provided for use by a grower of plants and flowers to hold a growing medium and grow the plants or flowers. Broadly, the decorative grower's container is provided with an outer peripheral surface and a floral grouping retaining space adapted to receive growing medium and a botanical item or propagule. To provide the decor to the decorative grower's container, a decorative pattern is applied to at least a portion of the outer peripheral surface of the grower's container. The decorative pattern may be applied to at least a portion of the outer peripheral surface of the grower's container either before the growing medium and botanical item or propagule are disposed in the floral grouping retaining space of the grower's container, after the growing medium and botanical item or propagule are disposed in the floral grouping retaining space of the grower's container, or after the botanical item or propagule has grown to a desired size for marketing but prior to shipment to wholesale or retail distribution points. At least a portion of the outer peripheral surface of the grower's container will be cleaned prior to the application of the decorative pattern or prior to marketing.

An object of the present invention is to provide a decorative grower's container.

Another object of the present invention, while achieving the before-stated object, is to provide methods for using a decorative grower's container by a grower of a botanical item or propagule.

Other objects, features and advantages of the present invention will become apparent from the following detailed description when read in conjunction with the accompanying drawings and appended claims.

### BRIEF DESCRIPTION OF THE DRAWINGS

FIG. 1 is a perspective view illustrating a grower's container of the prior art.

FIG. 2 is a perspective view illustrating the grower's container of FIG. 1 having a portion of an outer peripheral surface of a sidewall cleaned.

FIG. 3 is a perspective view illustrating the grower's container of FIG. 2 having a decorative pattern applied to the outer peripheral surface of the sidewall in accordance with the present invention.

FIG. 4 is a perspective view illustrating the decorative grower's container of FIG. 3 having growing medium and a floral grouping disposed within a floral grouping retaining space of the grower's container.

FIG. 5 is a perspective view illustrating the decorative grower's container of FIG. 4 having an outer peripheral surface of the sidewall of the decorative grower's container soiled to distort the decorative pattern applied thereto.

FIG. 6 is a perspective view illustrating the decorative grower's container of FIG. 5 having growing medium and a floral grouping disposed within the floral grouping retaining space of the decorative grower's container and having a portion of the outer peripheral surface of the sidewall of the decorative grower's container cleaned to display the decorative pattern applied thereon.

FIG. 7 is a perspective view illustrating a grower's container of the prior art.

FIG. 8 is a perspective view illustrating the grower's container of FIG. 7 having growing medium and a floral grouping disposed within the floral grouping retaining space of the grower's container, an outer peripheral surface of a sidewall the grower's container being soiled.

FIG. 9 is a perspective view illustrating the grower's container of FIG. 8 having a portion of the outer peripheral surface of the sidewall cleaned.

FIG. 10 is a perspective view illustrating the decorative grower's container of FIG. 9 having a decorative pattern applied to the clean area of the outer peripheral surface of the sidewall of the decorative grower's container.

FIG. 11 is a perspective view illustrating a decorative grower's container constructed in accordance with the present invention.

FIG. 12 is a perspective view illustrating the decorative grower's container of FIG. 11 having growing medium and a floral grouping disposed within a floral grouping retaining space of the decorative grower's container and having an outer peripheral surface of a sidewall of the decorative grower's container soiled to distort the decorative pattern applied thereto.

FIG. 13 is a perspective view illustrating the decorative grower's container of FIG. 12 having growing medium and a floral grouping disposed within the floral grouping retaining space of the decorative grower's container and having a portion of the outer peripheral surface of the sidewall of the decorative grower's container cleaned to display the decorative pattern applied thereon.

FIG. 14 is a bottom plan view illustrating the decorative grower's container of FIG. 11 wherein the grower's container is provided with a drain hole in a lower end thereof.

FIG. 15 is a diagrammatic illustration of a stopper for closing off the drain hole in the lower end of the decorative grower's container of FIG. 14.

FIG. 16 is a cross sectional view of the decorative grower's container of FIG. 14 having the stopper of FIG. 15 disposed in the drain hole in the lower end of the decorative grower's container.

### DESCRIPTION OF THE PREFERRED EMBODIMENTS

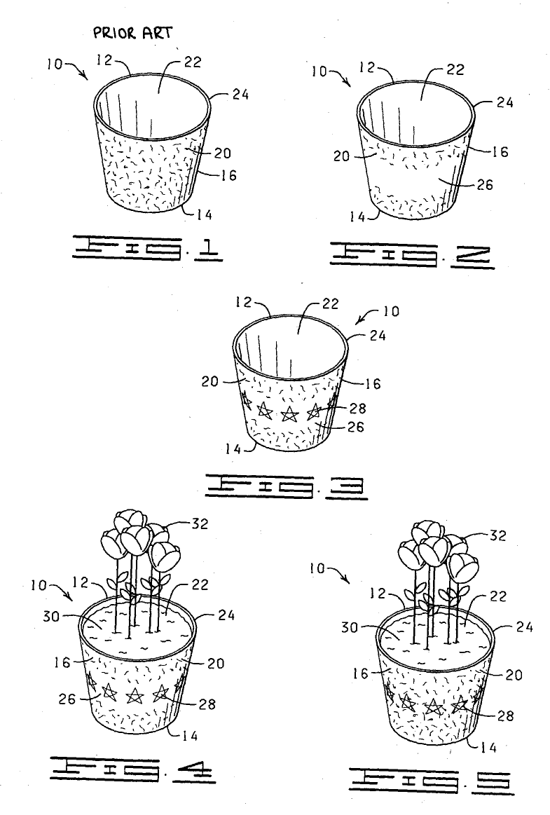

Shown in FIGS. 1-7 and designated therein by the general reference numeral 10 is a grower's container. The grower's container 10 is provided with an open upper end 12, a closed lower end 14, and a sidewall 16. The sidewall 16 has an outer peripheral surface 20. The closed lower end 14 and the sidewall 16 of the grower's container 10 cooperate to define a floral grouping retaining space 22, which is in open communication with the open upper end 12 of the grower's container 10. The floral grouping retaining space 22 of the grower's container 10 is adapted to receive growing medium and a floral grouping so that the floral grouping can be grown in the floral grouping retaining space 22 of the grower's container 10.

Containers suitable for use as the grower's container 10 are well known in the art. Such a grower's container 10 is constructed from a material 24 which may be polymeric materials, sandstone, clay, ceramic, porcelain, plaster, marble, glass, or any other suitable material or any other material constructed to be used by growers for such purposes. The thickness of the material 24 from which the grower's container 10 is constructed can vary widely, and the material 24 may be flexible or inflexible, as long as the material 24 is substantially shape-sustaining and can maintain a floral grouping and growing medium disposed within the floral grouping retaining space 22 of the grower's container 10. Generally, however, the thickness of the material 24 from which the grower's container 10 is constructed is in the range of from about 1.0 mil to about 50 mil. The term “container” may be used interchangeably herein with the term “pot”.

At least a portion of the outer peripheral surface 20 of the sidewall 16 of the grower's container 10 is cleaned to provide a clean area 26 on at least a portion of the outer peripheral surface 20 of the sidewall 16 of the grower's container 10, as shown in FIG. 2. The grower's container 10 may be cleaned by methods well known in the art, such as, but not by way of limitation, with water and/or mild soap.

As shown in FIG. 3, a decorative pattern 28 is then applied to the clean area 26 of the outer peripheral surface 20 of the sidewall 16 of the grower's container 10. The decorative pattern 28 provides the grower's container 10 with an aesthetically pleasing appearance.

The decorative pattern 28 may be applied to the outer peripheral surface 20 of the sidewall 16 of the grower's container 10 by several methods, including, but not limited to, painting, stenciling, texturing, printing, embossing, silk screening, applying stickers, and applying adhesive decorations. Application methods such as painting, stenciling and printing may require an ink or dye to provide the decorative pattern 28. An example of an ink which may be applied to the outer peripheral surface 20 of the sidewall 16 of the grower's container 10 is described in U.S. Pat. No. 5,147,706, entitled, “Water Based Ink On Foil And/Or Synthetic Organic Polymer”, issued to Kingman on Sep. 15, 1991, and which is hereby incorporated herein by reference. Alternatively, methods such as texturing and embossing may require depressions and impressions to be imprinted on the outer peripheral surface 20 of the sidewall 16 of the grower's container 10. Additionally, application methods involving silk screening, stickers and adhesive decorations may require a bonding material to be present on the decoration, the container or both.

The term “bonding material” as used herein means an adhesive, possibly a pressure sensitive adhesive, or a cohesive. Where the bonding material is a cohesive, a cohesive material is placed on both the decoration and the container for bondingly contacting and bondingly engaging the cohesive material. The term “bonding material” also includes materials which are heat sealable. The term “bonding material” as used herein also means a lacquer, which may be applied to the decoration and, in this instance, heat, sound waves, or vibrations also must be applied to effect the sealing of the lacquer. The bonding material may also be tinted or colored by using a dye, pigment or ink. U.S. Pat. No. 5,147,706 described immediately above provides one water based ink which may be used to tint the bonding material. In this manner, the bonding material may provide the decorative pattern 28 to the grower's container 10.

Each of the application methods may occur singly, that is, the outer peripheral surface 20 of the sidewall 16 of the grower's container 10 may be textured only or printed only, and the application methods may occur in any combination, that is, the outer peripheral surface 20 of the sidewall 16 of the grower's container 10 may be both printed and embossed. The combination of applications to enhance the decorative pattern 28 may be accomplished by applying the patterns either in register with one another, out of register with one another, or partially in register and partially out of register with one another. The applications may be present on a portion of the outer peripheral surface 20 or on the entire outer peripheral surface 20 of the sidewall 16 of the grower's container 10.

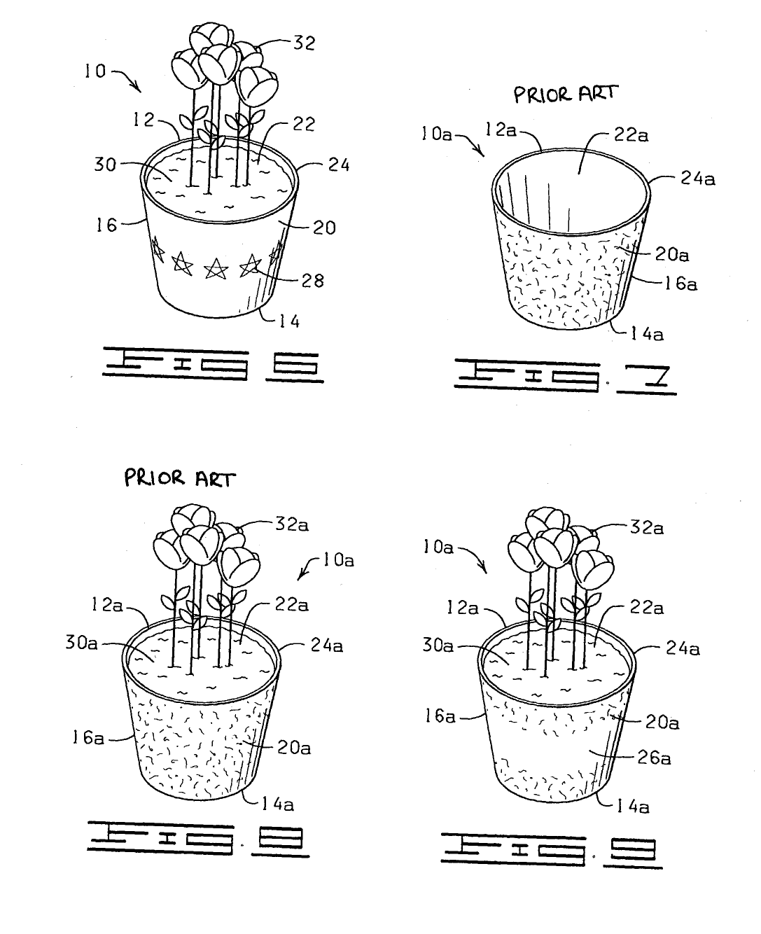

As shown in FIG. 4, a growing medium 30 and a floral grouping 32 are disposed in the floral grouping retaining space 22 of the grower's container 10 after application of the decorative pattern 28 to the outer peripheral surface 20 of the sidewall 16 of the grower's container 10, as shown in FIG. 4. Subsequently, the floral grouping 32 may be fed and watered until the floral grouping 32 has matured to a size desired for marketing. The processes of disposing the growing medium 30 and the floral grouping 32 in the grower's container 10, as well as feeding and watering the floral grouping 32, may soil the outer peripheral surface 20 of the sidewall 16 of the grower's container 10 containing the decorative pattern 28, as shown in FIG. 5, and therefore the outer peripheral surface 20 of the sidewall 16 of the grower's container 10 is then cleaned so that the decorative pattern 28 on at least a portion of the outer peripheral surface 20 of the sidewall 16 of the grower's container 10 is visible when the matured floral grouping 32 contained in the grower's container 10 is on display (FIG. 6).

The term “floral grouping” may be used interchangeably herein with the terms “plant” and/or “flower”. The term “floral grouping” may also be used interchangeably herein with the terms “botanical item” and/or “propagule”.

The term “botanical item” when used herein means a natural herbaceous or woody plant, taken singly or in combination. The term “botanical item” also means any portion or portions of natural herbaceous or woody plants including stems, leaves, flowers, blossoms, buds, blooms, cones, or roots, taken singly or in combination, or in groupings of such portions such as a bouquet or floral grouping.

The term “propagule” when used herein means any structure capable of being propagated or acting as an agent of reproduction including seeds, shoots, stems, runners, tubers, plants, leaves, roots or spores.

The term “growing medium” when used herein means any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

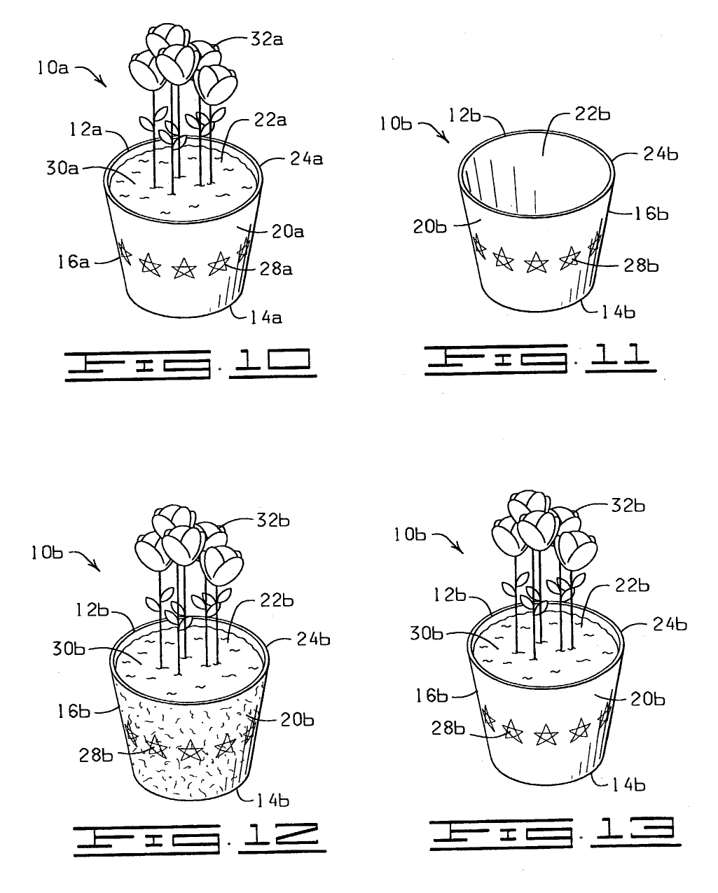

Now it will be understood that the order of the steps in the method as described herein may vary. For example, another method of use of the present invention is illustrated by FIGS. 7-10. A grower's container 10a illustrated in FIG. 7 and used in this method is constructed exactly the same as the grower's container 10 shown in FIG. 1, and is provided with an open upper end 12a, a closed lower end 14a, a sidewall 16a having an outer peripheral surface 20a, and a floral grouping retaining space 22a, and is constructed of a material 24a, as described in detail above. Growing medium 30a and a floral grouping 32a are then disposed in the floral grouping retaining space 22a of the grower's container 10a (FIG. 8), and the floral grouping 32a is fed, watered and allowed to mature to a marketable size. Next, a portion of the outer peripheral surface 20a of the sidewall 16a of the grower's container 10a is cleaned (FIG. 9) to provide a clean area 26a on a portion of the outer peripheral surface 20a of the sidewall 16a of the grower's container 10a, and a decorative pattern 28a is applied to at least a portion of the clean area 26a on the outer peripheral surface 20a of the sidewall 16a of the grower's container 10a (FIG. 10).

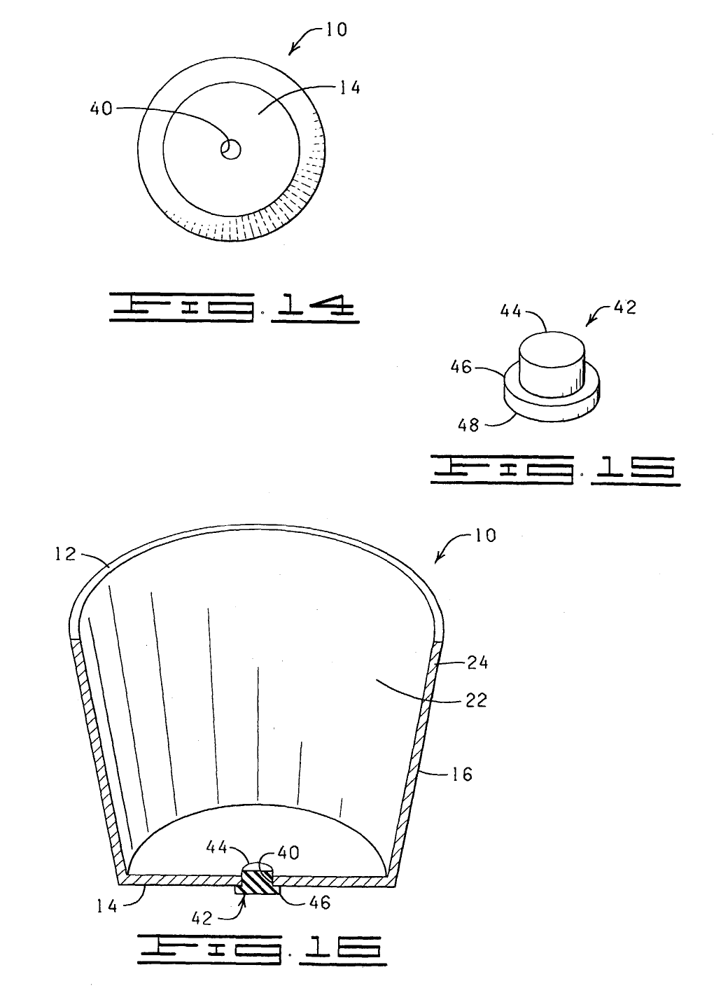

In another method of use illustrated by FIGS. 11-13, a decorative grower's container 10b is provided to the grower. The decorative grower's container 10b (FIG. 11) includes an open upper end 12b, a closed lower end 14b, and a sidewall 16b having an outer peripheral surface 20b. The closed lower end 14b and the sidewall 16b of the decorative grower's container 10b cooperate to define a floral grouping retaining space 22b, which is in open communication with the open upper end 12b of the decorative grower's container 10b. The decorative grower's container 10b is constructed of a material 24b. The decorative grower's container 10b is also provided with a decorative pattern 28b applied to at least a portion of the outer peripheral surface 20b of the sidewall 16b of the decorative grower's container 10b. Growing medium 30b and a floral grouping 32b are disposed in the floral grouping retaining space 22b of the decorative grower's container 10 as illustrated in FIG. 12, and the floral grouping 32b may be fed and watered until the floral grouping 32b has matured to a size desired for marketing. The processes of disposing the growing medium 30b and the floral grouping 32b in the decorative grower's container 10b, as well as feeding and watering the floral grouping 32b, may soil the outer peripheral surface 20b of the sidewall 16b of the decorative grower's container 10b containing the decorative pattern 28b, as shown in FIG. 12, and therefore the outer peripheral surface 20b of the sidewall 16b of the decorative grower's container 10b is then cleaned so that the decorative pattern 28b on at least a portion of the outer peripheral surface 20b of the sidewall 16b of the decorative grower's container 10b is visible when the matured floral grouping 32b contained in the decorative grower's container 10b is on display (FIG. 13).

In yet another method of use, a floral grouping 32b may be replanted by a grower in a decorative grower's container 10b as shown in FIG. 13 prior to sale of the floral grouping 32b by the grower. The decorative grower's container 10b used in this method is constructed exactly the same as the grower's container 10b shown in FIG. 11 and described in detail previously.

As shown in FIG. 14, the closed lower end 14 of the grower's container 10 of FIG. 1 is provided with a drain hole 40 extending there through. The drain hole 40 provides drainage and irrigation to the floral grouping retaining space 22 of the grower's container 10. The drain hole 40 is sized to prevent the loss of substantial amounts of growing medium 30 as well as the floral grouping 32 when growing medium 30 and the floral grouping 32 are disposed in the floral grouping retaining space 22 of the grower's container 10. The drain hole 40 may be located in the center of the closed lower end 14 of the grower's container 10, or it may be located peripherally and substantially close to the connection of the sidewall 16 to the closed lower end 14 of the grower's container 10.

As shown in FIGS. 15 and 16, a stopper 42 may also be provided with the grower's container 10 to close the drain hole 40 in the closed lower end 14 of the grower's container 10 when drainage and irrigation of the floral grouping retaining space 22 is not required. As shown in FIG. 15, the stopper 42 is provided with a plug member 44 adapted to be inserted into the drain hole 40, so that upon insertion of the stopper 42 into the drain hole 40, fluid will not be able to drain from the floral grouping retaining space 22 through the drain hole 40 of the grower's container 10.

The stopper 42 will be constructed of a fluid impermeable and slightly flexible but substantially shape-sustaining material such as, but not by way of limitation, rubber. The stopper 42 will also be provided with an outwardly extending flange 46 on a lower end 48 thereof, as shown in FIG. 15, and the flange 46 of the stopper 42 will allow for easy removal of the stopper 42 from the drain hole 40 of the grower's container 10. The flange 46 on the lower end 48 of the stopper 42 will be of such a size as to maintain the grower's container 10 in a steady, upright position.

It will be understood that the stopper 42 may be disposed in the drain hole 40 prior to or after any of the steps in the several methods described herein. The stopper 42 may also be removed from the drain hole 40 prior to or after any of the steps in the several methods described herein.

For the sake of brevity, the drain hole 40 and the stopper 42 described hereinbefore were only discussed in relation to the grower's container 10. However, it will be understood that any embodiments of the decorative grower's container contained herein, including the decorative grower's containers 10, 10a and 10b, will also be provided with a drain hole 40 and a stopper 42.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A decorative grower's container having a plant grown therein and having a decorative pattern thereon, the decorative pattern providing the decorative grower's container with an aesthetically pleasing appearance such that the decorative grower's container is not covered with a decorative flower pot cover or sleeve to hide the grower's container and the grown plant is not transplanted into a second container, wherein the decorative grower's container having the plant grown therein may be shipped from a grower's location to wholesale or retail distribution points for sale of the plant in the decorative grower's container, the decorative grower's container having a plant grown therein produced by a method comprising the steps of:
providing a grower's container to a grower of plants at a grower's location for growth of a plant at the grower's location, the grower's container having an open upper end, a closed lower end and a sidewall having an outer peripheral surface, the closed lower end and the sidewall of the grower's container cooperating to define a floral grouping retaining space in open communication with the open upper end of the grower's container;
cleaning at least a portion of the outer peripheral surface of the sidewall of the grower's container to provide a clean area on at least a portion of the outer peripheral surface of the sidewall of the grower's container;
applying a decorative pattern to a portion of the clean area on the outer peripheral surface of the sidewall of the grower's container to provide a decorative grower's container having an aesthetically pleasing appearance;
disposing growing medium and a floral grouping or propagule in the floral grouping retaining space of the decorative grower's container;
feeding and watering the floral grouping or propagule growing in the decorative grower's container until the floral grouping or propagule has matured to a size desired for marketing at wholesale or retail distribution points; and
shipping the decorative grower's container containing the floral grouping or propagule to a distributor at wholesale or retail distribution points so that the decorative pattern on a portion of the outer peripheral surface of the sidewall of the grower's container provides the aesthetically pleasing appearance to the decorative grower's container when the matured floral grouping or propagule contained in the decorative grower's container is on display at wholesale or retail distribution points, and wherein the aesthetically pleasing appearance is provided without the use of a decorative flower pot cover or sleeve and without transplanting the plant into a second container.

2. The decorative grower's container of claim 1 wherein, in the step of applying a decorative pattern to the clean area on the outer peripheral surface of the sidewall of the grower's container, the decorative pattern is provided by at least one of applying paint, stenciling, texturing, printing, embossing, silk screening, applying stickers, applying adhesive decorations, and combinations thereof to a portion of the clean area on the outer peripheral surface of the sidewall of the grower's container.

3. The decorative grower's container of claim 1 wherein, in the step of providing a grower's container, the grower's container is constructed of a material selected from the group consisting of polymeric material, sandstone, clay, ceramics, porcelain, plaster, marble and glass.

4. The decorative grower's container of claim 1 wherein, in the step of providing the grower's container, the closed lower end of the grower's container has a drain hole extending there through for providing irrigation and drainage to the growing medium and the floral grouping or propagule disposed in the floral grouping retaining space of the grower's container.

5. The decorative grower's container of claim 4 further comprising providing a stopper for closing off the drain hole in the closed lower end of the grower's container.

6. A decorative grower's container having a plant grown therein and having a decorative pattern thereon, the decorative pattern providing the decorative grower's container with an aesthetically pleasing appearance such that the decorative grower's container is not covered with a decorative flower pot cover or sleeve to hide the grower's container and the grown plant is not transplanted into a second container, wherein the decorative grower's container having the plant grown therein may be shipped from a grower's location to wholesale or retail distribution points for sale of the plant in the decorative grower's container, the decorative grower's container having a plant grown therein produced by a method comprising the steps of:
providing a grower's container to a grower of plants at a grower's location for growth of a plant at the grower's location, the grower's container having an open upper end, a closed lower end and a sidewall having an outer peripheral surface, the closed lower end and the sidewall of the grower's container cooperating to define a floral grouping retaining space in open communication with the open upper end of the grower's container;
disposing growing medium and a floral grouping or propagule in the floral grouping retaining space of the grower's container;
feeding and watering the floral grouping or propagule growing in the grower's container until the floral grouping or propagule matures to a size desired for marketing at wholesale or retail distribution points;
cleaning at least a portion of the outer peripheral surface of the sidewall of the grower's container at the grower's location prior to shipment of the grower's container having the floral grouping or propagule disposed therein to a distributor at wholesale or retail distribution points to provide a clean area on at least a portion of the outer peripheral surface of the sidewall of the grower's container;
applying a decorative pattern to a portion of the clean area on the outer peripheral surface of the sidewall of the grower's container at the grower's location to provide a decorative grower's container having an aesthetically pleasing appearance at the grower's location; and
shipping the decorative grower's container containing the floral grouping or propagule to a distributor at wholesale or retail distribution points so that the aesthetically pleasing appearance of the grower's container is visible when the matured floral grouping or propagule contained in the decorative grower's container is on display at wholesale or retail distribution points, and wherein the aesthetically pleasing appearance is provided to the decorative grower's container without the use of a decorative flower pot cover or sleeve and without transplanting the plant into a second container.

7. The decorative grower's container of claim 6 wherein, in the step of applying a decorative pattern to a portion of the clean area on the outer peripheral surface of the sidewall of the grower's container, the decorative pattern is provided by at least one of applying paint, stenciling, texturing, printing, embossing, silk screening, applying stickers, applying adhesive decorations, and combinations thereof to a portion of the clean area on the outer peripheral surface of the sidewall of the grower's container.

8. The decorative grower's container of claim 6 wherein, in the step of providing a grower's container, the grower's container is constructed of a material selected from the group consisting of polymeric material, sandstone, clay, ceramics, porcelain, plaster, marble and glass.

9. The decorative grower's container of claim 6 wherein, in the step of providing the grower's container, the closed lower end of the grower's container has a drain hole extending there through for providing irrigation and drainage to the growing medium and the floral grouping or propagule disposed in the floral grouping retaining space of the grower's container.

10. The decorative grower's container of claim 9 further comprising providing a stopper for closing off the drain hole in the closed lower end of the grower's container.

11. A decorative grower's container having a plant grown therein and having a decorative pattern thereon, the decorative pattern providing the decorative grower's container with an aesthetically pleasing appearance such that the decorative grower's container is not covered with a decorative flower pot cover or sleeve to hide the grower's container and the grown plant is not transplanted into a second container, wherein the decorative grower's container having the plant grown therein may be shipped from a grower's location to wholesale or retail distribution points for sale of the plant in the decorative grower's container, the decorative grower's container having a plant grown therein produced by a method comprising the steps of:
providing a decorative grower's container to a grower of plants at a grower's location for growth of a plant at the grower's location, the decorative grower's container having an open upper end, a closed lower end and a sidewall having an outer peripheral surface, a decorative pattern being provided on a portion of the outer peripheral surface of the sidewall of the decorative grower's container for providing an aesthetically pleasing appearance to the decorative grower's container, the closed lower end and the sidewall of the decorative grower's container cooperating to define a floral grouping retaining space in open communication with the open upper end of the decorative grower's container;
disposing growing medium and a floral grouping or propagule in the floral grouping retaining space of the decorative grower's container;
feeding and watering the floral grouping or propagule growing in the decorative grower's container until the floral grouping or propagule has matured to a size desired for marketing at wholesale or retail distribution points; and
shipping the decorative grower's container containing the floral grouping or propagule to a distributor at wholesale or retail distribution points so that the decorative pattern on a portion of the outer peripheral surface of the sidewall of the decorative grower's container provides the aesthetically pleasing appearance to the decorative grower's container when the matured floral grouping or propagule contained in the decorative grower's container is on display at wholesale or retail distribution points, and wherein the aesthetically pleasing appearance is provided without the use of a decorative flower pot cover or sleeve and without transplanting the plant into a second container.

12. The decorative grower's container of claim 11 wherein, in the step of providing a decorative grower's container, the decorative pattern is provided by at least one of applying paint, stenciling, texturing, printing, embossing, stickers, adhesive decorations, silk screen and combinations thereof to the outer peripheral surface of the sidewall of the decorative grower's container.

13. The decorative grower's container of claim 11 wherein, in the step of providing a decorative grower's container, the decorative grower's container is constructed from a material selected from the group consisting of polymeric material, sandstone, clay, ceramics, porcelain, plaster, marble and glass.

14. The decorative grower's container of claim 11 wherein, in the step of providing the decorative grower's container, the closed lower end of the decorative grower's container has a drain hole extending there through for providing irrigation and drainage to the growing medium and the floral grouping or propagule disposed in the floral grouping retaining space of the decorative grower's container.

15. The decorative grower's container of claim 14 further comprising providing a stopper for closing off the drain hole in the closed lower end of the decorative grower's container.
